(19) United States
(12) Patent Application Publication
(10) Pub. No.: US 2019/0061840 A1
(43) Pub. Date: Feb. 28, 2019

(54) AERODYNAMIC CONTROL ASSEMBLY AND A VEHICLE

(71) Applicant: GM Global Technology Operations LLC, Detroit, MI (US)

(72) Inventors: Samantha J. Bray, Northville, MI (US); Joshua R. Auden, Brighton, MI (US); Jason D. Fahland, Fenton, MI (US)

(73) Assignee: GM Global Technology Operations LLC, Detroit, MI (US)

(21) Appl. No.: 15/685,673

(22) Filed: Aug. 24, 2017

(51) Int. Cl. B62D 35/00; B62D 37/02

(52) U.S. Cl. CPC B62D 35/007; B62D 37/02

(57) ABSTRACT

An aerodynamic control assembly includes a support structure and a wing member supported by the support structure. The wing member is movable between a first position relative to the support structure and a second position relative to the support structure. The aerodynamic control assembly also includes an actuator coupled to the wing member. The actuator is configured to move the wing member between the first and second positions. The aerodynamic control assembly further includes an inertia measurement unit (IMU) secured to the wing member. The IMU is configured to compile data regarding the position of the wing member.

A vehicle includes a body structure and the aerodynamic control assembly coupled to the body structure. The aerodynamic control assembly includes a support structure fixed to the body structure. The aerodynamic control assembly also includes the wing member, the actuator and the IMU discussed above.

### INTRODUCTION

Vehicles have been designed with aerodynamic systems, such as an adjustable spoiler which can change the downforce applied to the vehicle.

### SUMMARY

The present disclosure provides an aerodynamic control assembly that includes a support structure and a wing member supported by the support structure. The wing member is movable between a first position relative to the support structure and a second position relative to the support structure. The aerodynamic control assembly also includes an actuator coupled to the wing member. The actuator is configured to move the wing member between the first and second positions. The aerodynamic control assembly further includes an inertia measurement unit (IMU) secured to the wing member. The IMU is configured to compile data regarding the position of the wing member.

The aerodynamic control assembly optionally includes one or more of the following:

A) a pivot point coupled to the wing member to allow the wing member to move between the first and second positions;

B) the IMU is spaced from the pivot point;

C) the wing member includes a first end and a second end spaced from each other, with the pivot point disposed between the first and second ends;

D) the IMU is disposed closer to the second end than the first end;

E) a controller in communication with the IMU to receive the compiled data, and in communication with the actuator to control the position of the wing member in light of the compiled data from the IMU;

F) the IMU is further defined as a first IMU;

G) a second IMU secured to the wing member and spaced from the first IMU;

H) the first IMU and second IMU are spaced from the pivot point;

I) a controller in communication with the actuator, the first IMU and the second IMU such that data compiled from the first IMU and the second IMU are utilized to control the position of the wing member via the actuator;

J) the first IMU and the second IMU each include an accelerometer;

K) the controller is in communication with the accelerometer such that data compiled from the accelerometer is utilized to control the position of the wing member via the actuator;

L) the first IMU and the second IMU each include a gyroscope;

M) the controller is in communication with the gyroscope such that data compiled from the gyroscope is utilized to control the position of the wing member via the actuator;

N) the IMU includes an accelerometer; and

O) the IMU includes a gyroscope.

The present disclosure also provides a vehicle that includes a body structure and an aerodynamic control assembly coupled to the body structure. The aerodynamic control assembly includes a support structure fixed to the body structure. The aerodynamic control assembly also includes a wing member supported by the support structure. The wing member is movable between a first position relative to the support structure and a second position relative to the support structure. The aerodynamic control assembly also includes an actuator coupled to the wing member. The actuator is configured to move the wing member between the first and second positions. Additionally, the aerodynamic control assembly includes an inertia measurement unit (IMU) secured to the wing member. The IMU is configured to compile data regarding the position of the wing member.

The vehicle optionally includes one or more of the following:

A) a pivot point coupled to the wing member to allow the wing member to move between the first and second positions;

B) the IMU is spaced from the pivot point;

C) the wing member includes a first end and a second end spaced from each other, with the pivot point disposed between the first and second ends;

D) the IMU is disposed closer to the second end than the first end;

E) a controller in communication with the IMU to receive the compiled data, and in communication with the actuator to control the position of the wing member in light of the compiled data from the IMU;

F) the IMU includes an accelerometer configured to compile data regarding motion of the body structure;

G) a controller in communication with the IMU, the accelerometer and the actuator such that data compiled from the accelerometer and the IMU are utilized to control the position of the wing member via the actuator;

H) the IMU is configured to compile data regarding yaw and roll of the body structure; and

I) a controller in communication with the IMU and the actuator such that data compiled from the IMU regarding yaw and roll are utilized to control the position of the wing member via the actuator.

The detailed description and the drawings or FIGS. are supportive and descriptive of the disclosure, but the claim scope of the disclosure is defined solely by the claims. While some of the best modes and other embodiments for carrying out the claims have been described in detail, various alternative designs and embodiments exist for practicing the disclosure defined in the appended claims.

### BRIEF DESCRIPTION OF THE DRAWINGS

FIG. 1 is a schematic side view of a vehicle and an aerodynamic control assembly.

FIG. 2 is a schematic enlarged side view of the aerodynamic control assembly.

FIG. 3 is a schematic perspective view of one example of a wing member.

### DETAILED DESCRIPTION

Those having ordinary skill in the art will recognize that all directional references (e.g., above, below, upward, up, downward, down, top, bottom, left, right, vertical, horizontal, etc.) are used descriptively for the FIGS. to aid the reader's understanding, and do not represent limitations (for example, to the position, orientation, or use, etc.) on the scope of the disclosure, as defined by the appended claims.

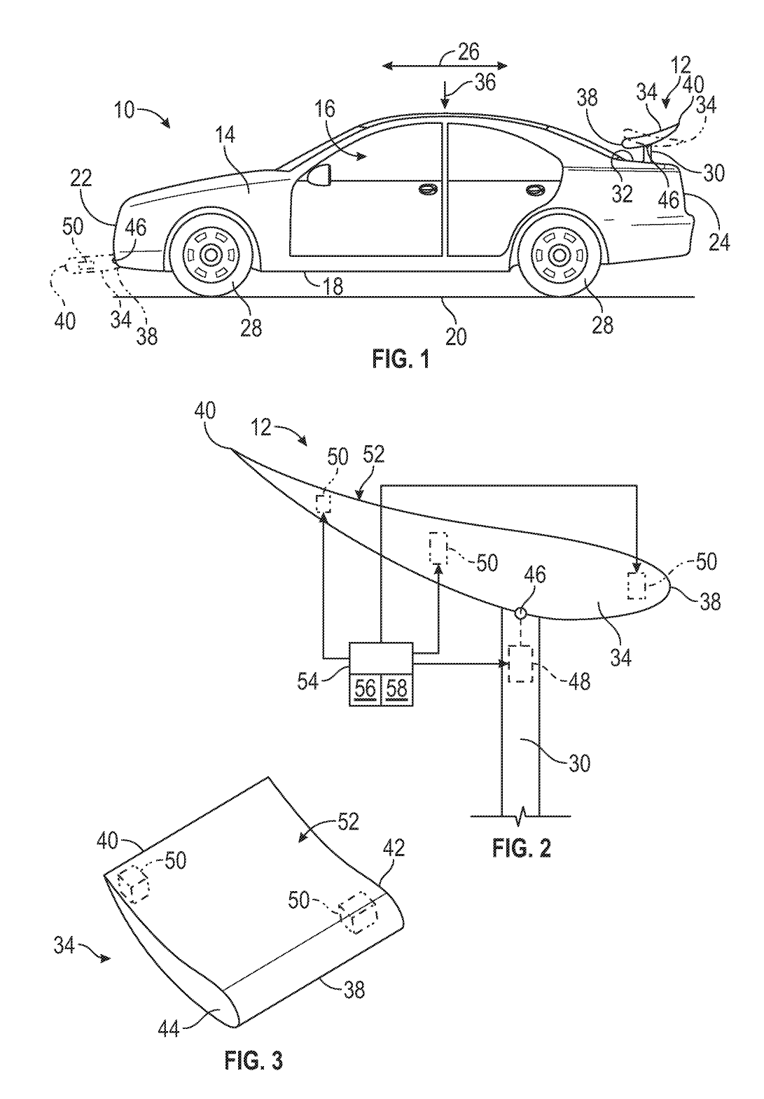

Referring to the FIGS., wherein like numerals indicate like or corresponding parts throughout the several views, a vehicle 10 and an aerodynamic control assembly 12 are generally shown in FIG. 1.

The aerodynamic control assembly 12 can be utilized in a vehicle application or a non-vehicle application. Non-limiting examples of the vehicles 10 can include cars, sports car, race car, trucks, off-road vehicles 10, motorcycles, aircrafts, farm equipment or any other suitable movable platform. Additionally, the vehicle 10 can include autonomously driven vehicles or vehicles driven via a human. Non-limiting examples of the non-vehicles can include machines, farm equipment or any other suitable non-vehicle.

For the vehicle application as shown in FIG. 1, the vehicle 10 can include a body structure 14. In certain embodiments, the aerodynamic control assembly 12 can be coupled to the body structure 14. Additionally, the body structure 14 can define a passenger compartment 16. Generally, one or more occupants can be disposed in the passenger compartment 16. Furthermore, for a vehicle 10 driven by the human, one of the occupants can steer the vehicle 10 from the passenger compartment 16. The passenger compartment 16 can have one or more doors that open and close to allow the occupants to enter and exit the vehicle 10.

Referring to FIG. 1, the body structure 14 can also include an interior compartment and a bottom panel 18 that defines a bottom of the interior compartment. In certain embodiments, the interior compartment can be an engine compartment or a storage compartment. Generally, the interior compartment can be spaced from the passenger compartment 16.

Additionally, the bottom panel 18 can include an inner surface facing the interior compartment and an outer surface opposing the inner surface to face away from the interior compartment. Therefore, generally, the outer surface of the bottom panel 18 faces the ground 20 that the vehicle 10 travels over. In certain embodiments, the bottom panel 18 can include a belly pan.

Referring to FIG. 1, the body structure 14 can include a front end 22 and a rear end 24, with a plurality of fascia pieces or panels, some or all of which are visible from the outside of the passenger compartment 16 of the vehicle 10. The front and rear ends 22, 24 are spaced from each other along a length 26 (see arrow 26 in FIG. 1) of the vehicle 10. Generally, the fascia pieces or panels surround the vehicle 10. The vehicle 10 can also include one or more wheels 28, and therefore, depending on the number of wheels 28 that the vehicle 10 utilizes, one or more of the fascia pieces can be configured to allow the wheel 28 to be disposed under part of the vehicle 10.

The fascia pieces or panels can include one or more of: a front panel which can include a front bumper fascia, a rear panel which can include a rear bumper fascia, and side panel(s) which can include front quarter panel fascia(s) and rear quarter panel fascia(s). FIG. 1 best illustrates one side of the vehicle 10, and it is to be appreciated that the other side of the vehicle 10 can be a mirror image of the illustrated side. The sides of the vehicle 10 are spaced from each other in a cross-car direction. The cross-car direction is transverse or perpendicular to the length 26 of the vehicle 10. In other words, the rear and front quarter panel fascias along one side of the vehicle 10 are spaced in the cross-car direction from the rear and front quarter panel fascias along the other side of the vehicle 10.

Generally, the front bumper fascia can be disposed along the front end 22 of the vehicle 10 and the rear bumper fascia can be disposed along the rear end 24 of the vehicle 10. Therefore, the front quarter panel fascia(s) can be disposed adjacent to the front bumper fascia and the rear quarter panel fascia(s) can be disposed adjacent to the rear bumper fascia.

Referring to FIGS. 1 and 2, the aerodynamic control assembly 12 includes a support structure 30. The support structure 30 can be secured to a component. In the vehicle application, the support structure 30 can be secured to part of the vehicle 10, and thus the component can be part of the vehicle 10. For example, the component can include the body structure 14, and thus, the support structure 30 can be fixed to the body structure 14. As another example, the component can include one of the panels, and therefore, in certain embodiments, the support structure 30 can be secured to a top 32 of one of the panels at the rear end 24 of the vehicle 10. The support structure 30 is fixed to the component by any suitable methods, and non-limiting examples can include one or more of fastener(s), welding, adhesive, coupler(s), press fit, interference fit, etc., and combinations thereof. As non-limiting examples, the support structure 30 can be one or more posts and/or part of the body structure 14 such as a front bumper.

Continuing with FIGS. 1 and 2, the aerodynamic control assembly 12 also includes a wing member 34 supported by the support structure 30. The wing member 34 is movable between a first position relative to the support structure 30 and a second position relative to the support structure 30. FIG. 1 illustrates examples of two different positions of the wing member 34 proximal to the rear end 24 of the vehicle 10, one in solid lines and one in phantom lines for illustrative purposes only. It is to be appreciated that the wing member 34 can move in other positions than illustrated.

An airflow can pass across the wing member 34 as the vehicle 10 travels across the ground 20. Depending on the position of the wing member 34, the airflow can be changed, which can change the vehicle's aerodynamic characteristics. For example, the wing member 34 is movable to change a downforce 36 (see arrow 36 in FIG. 1) applied to the vehicle 10 as the vehicle 10 travels across the ground 20. Therefore, the wing member 34 can adjust performance characteristics of the vehicle 10. The wing member 34 can be configured such that the airflow passes over the top of the wing member 34 relative to the ground 20, or alternatively, the wing member 34 can be configured such that the airflow passes over the top of the wing member 34 and the bottom of the wing member 34 relative to the ground 20.

The wing member 34 can include one or more of a spoiler or a wing disposed at any location along a top of the vehicle 10, a dive wing disposed at any location along a corner of the vehicle 10, a gurney flap disposed at any location along the front end 22 of the vehicle 10 or disposed on a spoiler, a front splitter disposed at any location along the front end 22 of the vehicle 10 (example of the front splitter shown in FIG. 1), a front air dam disposed at any location along the front end 22 of the vehicle 10, etc. It is to be appreciated that more than one wing member 34 can be utilized. Each of the wing members 34 can include one or more of the features discussed herein for the single wing member 34.

The wing member 34 can be any suitable configuration, and FIG. 1 illustrates two different examples of the wing member 34. For example, the wing member 34 can be disposed closer to the rear end 24 of the vehicle 10 than the front end 22 of the vehicle 10. Specifically, the wing member 34 can be supported by a trunk lid of the vehicle 10 proximal to the rear end 24. As another example, the wing member 34 can be disposed closer to the front end 22 of the vehicle 10 than the rear end 24 of the vehicle 10. Specifically, the wing member 34 can be supported by a front bumper of the vehicle 10 at the front end 22 (this wing member 34 is shown in phantom lines at the front end 22). It is to be appreciated that the wing member 34 at the front end 22 of the vehicle 10 is exaggerated for illustrative purposes only.

As best shown in FIG. 1, the wing member 34 can include a first end 38 and a second end 40 spaced from each other. In certain embodiments, the first end 38 of the wing member 34 can be disposed closer to the passenger compartment 16 than the second end 40 of the wing member 34. Furthermore, as best shown in FIG. 3, the wing member 34 can include a first side 42 and a second side 44 spaced from each other. Generally, the first and second sides 42, 44 are spaced from each other in the cross-car direction. As such, in certain embodiments, the wing member 34 can be elongated in the cross-car direction.

As best shown in FIG. 2, the aerodynamic control assembly 12 can include a pivot point 46 coupled to the wing member 34 to allow the wing member 34 to move between the first and second positions. In certain embodiments, the pivot point 46 can be disposed between the first and second ends 38, 40 of the wing member 34. For example, as shown in FIG. 1, the wing member 34 that is proximal to the rear end 24 illustrates the pivot point 46 between the first and second ends 38, 40. In other embodiments, the pivot point 46 can be disposed at one of the first and second ends 38, 40 of the wing member 34. For example, as shown in FIG. 1, the wing member 34 that is proximal to the front end 22 illustrates the pivot point 46 at the first end 38.

Continuing with FIG. 2, the aerodynamic control assembly 12 further includes an actuator 48 coupled to the wing member 34. The actuator 48 is configured to move the wing member 34 between the first and second positions. The actuator 48 can be coupled to the wing member 34 in any suitable location to move the wing member 34 between the positions. In certain embodiments, the actuator 48 can be disposed inside or outside of the support structure 30. In other embodiments, the actuator 48 can be coupled or attached to the body structure 14. In yet other embodiments, the actuator 48 can be disposed inside the wing member 34. The actuator 48 can include a motor, a solenoid, an arm and/or any other suitable apparatus to move the wing member 34 to the desired position.

Additionally, referring to FIGS. 1-3, the aerodynamic control assembly 12 includes an inertia measurement unit (IMU) 50 secured to the wing member 34. In certain embodiments, the IMU 50 can be disposed inside the wing member 34. Said differently, the IMU 50 can be embedded into the wing member 34. In other embodiments, the IMU 50 is disposed along one or more outer surfaces 52 of the wing member 34. Generally, the outer surfaces 52 of the wing member 34 can be visible from outside of the vehicle 10, and therefore, the outer surfaces 52 of the wing member 34 are generally smooth for aerodynamic purposes. If utilizing more than one wing member 34, one or more IMUs 50 can be utilized with each of the wing members 34. A plurality of IMUs 50 is discussed further below. Additionally, if utilizing more than one wing member 34, one or more actuators 48 can be utilized. Each of the actuators 48 can include one or more of the features discussed herein for the single actuator 48.

FIGS. 2 and 3 illustrate examples of different suitable locations of the IMU 50. It is to be appreciated that the IMU 50 can be in other locations than illustrated. In certain embodiments, the IMU 50 is spaced from the pivot point 46. Therefore, in certain embodiments, the IMU 50 can be disposed closer to the second end 40 of the wing member 34 than the first end 38 of the wing member 34. In other embodiments, the IMU 50 can be disposed closer to the first end 38 of the wing member 34 than the second end 40 of the wing member 34. Furthermore, in certain embodiments, the IMU 50 can be disposed closer to the first side 42 of the wing member 34 than the second side 44 of the wing member 34. In other embodiments, the IMU 50 can be disposed closer to the second side 44 of the wing member 34 than the first side 42 of the wing member 34.

Generally, the IMU 50 can compile data regarding the vehicle 10 to optimize the downforce 36 of the vehicle 10, which can improve control of the vehicle 10. As such, the IMU 50 can compile data regarding yaw, roll and pitch of the vehicle 10 relative to the ground 20. For example, the IMU 50 is configured to compile data regarding the position of the wing member 34. Specifically, the IMU 50 can compile data regarding the position of the wing member 34 relative to the ground 20. Furthermore, the IMU 50 can compile data regarding the motion of the vehicle 10. For example, the IMU 50 can be configured to compile data regarding yaw and roll of the body structure 14. Additionally, the IMU 50 can compile data regarding the amount of downforce 36 applied to the wing member 34. Therefore, utilizing the IMU 50 with the wing member 34 can assist in determining the optimal position of the wing member 34 and/or more accurately controlling the downforce 36 of the vehicle 10.

In certain embodiments, the IMU 50 can include an accelerometer. The accelerometer can include a single-axis type of accelerometer or a multi-axis type of accelerometer. For example, the accelerometer can be configured to compile data regarding motion of the body structure 14, such as acceleration, velocity and/or the rate of change of velocity of the body structure 14.

In other embodiments, the IMU 50 can include a gyroscope. The gyroscope can detect multiple degrees of motion of the vehicle 10. Therefore, the gyroscope can detect yaw, roll and pitch of the vehicle 10. In yet other embodiments, the IMU 50 can include both the accelerometer and the gyroscope.

Referring to FIG. 2, the aerodynamic control assembly 12 can include a controller 54 in communication with the IMU 50 to receive the compiled data, and in communication with the actuator 48 to control the position of the wing member 34 in light of the compiled data from the IMU 50. For example, the controller 54 can be in communication with the IMU 50 and the actuator 48 such that data compiled from the IMU 50 regarding yaw and roll are utilized to control the position of the wing member 34 via the actuator 48. In certain embodiments, the controller 54 can be in communication with the accelerometer such that data compiled from the accelerometer is utilized to control the position of the wing member 34 via the actuator 48. Therefore, the controller 54 can be in communication with the IMU 50, the accelerometer and the actuator 48 such that data compiled from the accelerometer and the IMU 50 are utilized to control the position of the wing member 34 via the actuator 48. Furthermore, in certain embodiments, the controller 54 can be in communication with the gyroscope such that data compiled from the gyroscope is utilized to control the position of the wing member 34 via the actuator 48.

Instructions can be stored in a memory 56 of the controller 54 and automatically executed via a processor 58 of the controller 54 to provide the respective control functionality. The controller 54 is configured to execute the instructions from the memory 56, via the processor 58. For example, the controller 54 can be a host machine or distributed system, e.g., a computer such as a digital computer or microcomputer, and, as the memory 56, tangible, non-transitory computer-readable memory such as read-only memory (ROM) or flash memory. The controller 54 can also have random access memory (RAM), electrically erasable programmable read-only memory (EEPROM), a high-speed clock, analog-to-digital (A/D) and/or digital-to-analog (D/A) circuitry, and any required input/output circuitry and associated devices, as well as any required signal conditioning and/or signal buffering circuitry. Therefore, the controller 54 can include all software, hardware, memory 56, algorithms, connections, sensors, etc., necessary to control and/or communication, for example, with the actuator 48 and the IMU(s) 50. As such, a control method operative to control the actuator 48, can be embodied as software or firmware associated with the controller 54. It is to be appreciated that the controller 54 can also include any device capable of analyzing data from various sensors, comparing data, making the necessary decisions required to control, monitor and/or communicate with the actuator 48 and/or the IMU(s) 50.

Optionally, more than one controller 54 can be utilized. For example, if one or more IMUs 50 are being utilized in separate wing members 34, then one controller 54 can be in communication with all of the IMUs 50, or more than one controller 54 can be in communication with various IMUs 50. If utilizing a plurality of controllers 54, each of the controllers 54 can optionally be in communication with each other. Each of the controllers 54 can include one or more of the features discussed herein for the single controller 54.

As mentioned above, the aerodynamic control assembly 12 can include more than one IMU 50. Each of the IMUs 50 can include one or more of the features discussed herein for the single IMU 50. In certain embodiments, the IMU 50 is further defined as a first IMU 50, and the aerodynamic control assembly 12 can include a second IMU 50 secured to the wing member 34 and spaced from the first IMU 50. In certain embodiments, the first IMU 50 and second IMU 50 are spaced from the pivot point 46. The first and second IMUs 50 can be in any of the locations discussed above. In this embodiment, the controller 54 can be in communication with the actuator 48, the first IMU 50 and the second IMU 50 such that data compiled from the first IMU 50 and the second IMU 50 are utilized to control the position of the wing member 34 via the actuator 48.

In certain embodiments, the first IMU 50 and the second IMU 50 can each include an accelerometer. Examples of the features of the accelerometer are discussed above, and will not be re-discussed. In this embodiment, the controller 54 can be in communication with the accelerometer of each of the IMUs 50 such that data compiled from the accelerometer of each of the IMUs 50 is utilized to control the position of the wing member 34 via the actuator 48. Furthermore, in certain embodiments, the first IMU 50 and the second IMU 50 each include a gyroscope. Examples of the features of the gyroscope are discussed above, and will not be re-discussed. In this embodiment, the controller 54 is in communication with the gyroscope of each of the IMUs 50 such that data compiled from the gyroscope of each of the IMUs 50 is utilized to control the position of the wing member 34 via the actuator 48.

The aerodynamic control assembly 12 discussed herein can eliminate the use of position sensors disposed along the wing member 34. Position sensors can detect pitch of the vehicle 10 but cannot detect yaw and roll of the vehicle 10. The aerodynamic control assembly 12 can be utilized with an active system. In other words, as the vehicle 10 is moving, the wing member 34 can be adjusted automatically due to data regarding the vehicle 10, e.g., the vehicle 10 accelerating, the vehicle 10 decelerating, the vehicle 10 stopping, the vehicle 10 turning, the vehicle 10 traveling straight, etc.; the wing member 34 and/or the ground 20.

While the best modes and other embodiments for carrying out the disclosure have been described in detail, those familiar with the art to which this disclosure relates will recognize various alternative designs and embodiments for practicing the disclosure within the scope of the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

What is claimed is:

1. An aerodynamic control assembly comprising:
a support structure;
a wing member supported by the support structure and movable between a first position relative to the support structure and a second position relative to the support structure;
an actuator coupled to the wing member and configured to move the wing member between the first and second positions; and
an inertia measurement unit (IMU) secured to the wing member and configured to compile data regarding the position of the wing member.

2. The assembly as set forth in claim 1 further including a pivot point coupled to the wing member to allow the wing member to move between the first and second positions, and wherein the IMU is spaced from the pivot point.

3. The assembly as set forth in claim 2 wherein the wing member includes a first end and a second end spaced from each other, with the pivot point disposed between the first and second ends, and wherein the IMU is disposed closer to the second end than the first end.

4. The assembly as set forth in claim 3 further including a controller in communication with the IMU to receive the compiled data, and in communication with the actuator to control the position of the wing member in light of the compiled data from the IMU.

5. The assembly as set forth in claim 1 wherein the IMU is further defined as a first IMU, and further including a second IMU secured to the wing member and spaced from the first IMU.

6. The assembly as set forth in claim 5 further including a pivot point coupled to the wing member to allow the wing member to move between the first and second positions, and wherein the first IMU and second IMU are spaced from the pivot point.

7. The assembly as set forth in claim 5 further including a controller in communication with the actuator, the first IMU and the second IMU such that data compiled from the first IMU and the second IMU are utilized to control the position of the wing member via the actuator.

8. The assembly as set forth in claim 7 wherein the first IMU and the second IMU each include an accelerometer, and wherein the controller is in communication with the accelerometer of each of the IMUs such that data compiled from the accelerometer of each of the IMUs is utilized to control the position of the wing member via the actuator.

9. The assembly as set forth in claim 7 wherein the first IMU and the second IMU each include a gyroscope, and wherein the controller is in communication with the gyroscope of each of the IMUs such that data compiled from the gyroscope of each of the IMUs is utilized to control the position of the wing member via the actuator.

10. The assembly as set forth in claim 1 further including a controller in communication with the IMU to receive the compiled data, and in communication with the actuator to control the position of the wing member in light of the compiled data from the IMU.

11. The assembly as set forth in claim 1 wherein the IMU includes an accelerometer.

12. The assembly as set forth in claim 1 wherein the IMU includes a gyroscope.

13. The assembly as set forth in claim 1:
further including a pivot point coupled to the wing member to allow the wing member to move between the first and second positions, and wherein the IMU is spaced from the pivot point;
wherein the wing member includes a first end and a second end spaced from each other, with the pivot point disposed between the first and second ends, and wherein the IMU is disposed closer to the second end than the first end;
further including a controller in communication with the IMU to receive the compiled data, and in communication with the actuator to control the position of the wing member in light of the compiled data from the IMU;
wherein the IMU includes an accelerometer;
wherein the controller is in communication with the accelerometer such that data compiled from the accelerometer is utilized to control the position of the wing member via the actuator;
wherein the IMU includes a gyroscope; and
wherein the controller is in communication with the gyroscope such that data compiled from the gyroscope is utilized to control the position of the wing member via the actuator.

14. A vehicle comprising:
a body structure;
an aerodynamic control assembly coupled to the body structure and the assembly includes:
a support structure fixed to the body structure;
a wing member supported by the support structure and movable between a first position relative to the support structure and a second position relative to the support structure;
an actuator coupled to the wing member and configured to move the wing member between the first and second positions; and
an inertia measurement unit (IMU) secured to the wing member and configured to compile data regarding the position of the wing member.

15. The vehicle as set forth in claim 14 further including a pivot point coupled to the wing member to allow the wing member to move between the first and second positions, and wherein the IMU is spaced from the pivot point.

16. The vehicle as set forth in claim 15 wherein the wing member includes a first end and a second end spaced from each other, with the pivot point disposed between the first and second ends, and wherein the IMU is disposed closer to the second end than the first end.

17. The vehicle as set forth in claim 16 further including a controller in communication with the IMU to receive the compiled data, and in communication with the actuator to control the position of the wing member in light of the compiled data from the IMU.

18. The vehicle as set forth in claim 14 wherein the IMU includes an accelerometer configured to compile data regarding motion of the body structure, and further including a controller in communication with the IMU, the accelerometer and the actuator such that data compiled from the accelerometer and the IMU are utilized to control the position of the wing member via the actuator.

19. The vehicle as set forth in claim 14 wherein the IMU is configured to compile data regarding yaw and roll of the body structure, and further including a controller in communication with the IMU and the actuator such that data compiled from the IMU regarding yaw and roll are utilized to control the position of the wing member via the actuator.
